(19) United States
(12) Patent Application Publication
(10) Pub. No.: US 2013/0278565 A1
(43) Pub. Date: Oct. 24, 2013

(54) METHOD AND APPARATUS FOR PROVIDING GRAPHIC KEYBOARD IN TOUCH-SCREEN TERMINAL

(71) Applicant: Samsung Electronics Co., Ltd., Gyeonggi-do (KR)

(72) Inventor: Jin PARK, Gyeonggi-do (KR)

(21) Appl. No.: 13/855,287

(22) Filed: Apr. 2, 2013

(30) Foreign Application Priority Data
Apr. 2, 2012 (KR) 10-2012-0033993

(51) Int. Cl. G06F 3/041

(52) U.S. Cl. CPC G06F 3/0418
USPC 345/178

(57) ABSTRACT

A method for providing a graphic keyboard in a touch-screen terminal is provided. In the method, a keyboard is divided into a plurality of key group regions. A key display aspect of each key group region is determined. Shapes or layouts of keys of each key group region are controlled depending on the key display aspect. Another method involves determining a characteristic of a contact area of at least one touch on at least one graphic key of a displayed keyboard. Shape or layout of the at least one key is controlled based on the determined characteristic.

### CLAIM OF PRIORITY

This application claims the benefit under 35 U.S.C. §119(a) of a Korean patent application filed in the Korean Intellectual Property Office on Apr. 2, 2012 and assigned Serial No. 10-2012-0033993, the entire disclosure of which is hereby incorporated by reference.

### BACKGROUND

1. Technical Field

The present disclosure relates generally to a touch-screen terminal, and more particularly, to methods and apparatus for providing a graphic keyboard in a touch-screen terminal.

2. Description of the Related Art

Currently, with recent technological progress in electronics and telecommunications, portable terminals such as mobile communication terminals (e.g., smart phones); electronic schedulers, Personal Digital Assistants (PDAs), tablet PCs, etc. have proliferated in society.

Furthermore, as the utility of touch-screens has increased, more and more users tend to favor a portable terminal with a touch-screen. Generally, a touch-screen portable terminal provides a graphic keyboard, commonly called a “virtual keyboard”, via the touch-screen. The keyboard contains a set of key elements (keys). Compared to the conventional hardware keyboard, a user may easily input a character by just touching a key on a screen.

Conventional virtual keyboards in hand held devices are small, which results in frequent erroneous input. Because the keys are small, a user must take great care in touching the intended keys to prevent inputting errors. This is especially true when the user uses his thumb(s) to touch the keys. For instance, a user may attempt to type with his thumb while gripping a portable terminal, all with one hand, which requires that the thumb reach across the keyboard to access the distant keys. This operation causes even more frequent typographic errors.

Therefore, it would be desirable to provide a graphic keyboard in a touch screen that can be designed to reduce the occurrence of typographic errors.

### SUMMARY

Disclosed is a graphic keyboard in a touch screen device, which is designed to reduce typographic errors via a configuration tailored to a personal touch characteristic.

Also disclosed is a method and apparatus for providing a graphic keyboard that controls a key array, for example, a size or a width of a key, a spacing between keys, a key slope, etc. depending on a characteristic of contact areas between a user's finger and a touch-screen, for example, sizes of the contact areas, shapes of the contact areas, etc.

In an embodiment, a method for providing a graphic keyboard in a touch-screen terminal is provided. A graphic keyboard display area is divided into a plurality of key group regions. A key display aspect of each key group region is determined. Shape or layout of at least one key in each key group region is controlled based on the key display aspect of that group.

In another embodiment, a method for providing a graphic keyboard in a touch-screen terminal includes: determining a characteristic of a contact area of at least one touch on at least one graphic key of a displayed keyboard; and controlling a shape or layout of the at least one key based on the determined characteristic.

In an embodiment, an electronic device for providing a graphic keyboard comprises: a touch-screen; a memory; and at least one processor, wherein the at least one processor executes at least one module stored in the memory, and the module divides a keyboard display area into a plurality of key group regions, determines a key display aspect of each key group region, and controls a shape or layout of at least one key of each key group region based on the key display aspect of that group.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a block diagram illustrating an electronic device according to an exemplary embodiment of the present invention;

FIG. 2 is a flowchart illustrating a method for providing a graphic keyboard according to an exemplary embodiment of the present invention;

FIG. 3 is a view illustrating an example of dividing a keypad into a plurality of key group regions according to an exemplary embodiment of the present invention;

FIG. 4 is a view illustrating exemplary characteristics of contact areas of touches for different key group regions of a keyboard;

FIG. 5 is a view illustrating an example of arraying keys of each key group region depending on the characteristic(s) of the contact areas;

FIG. 6 is a view illustrating characteristics of contact areas of touches for different key group regions of a keyboard;

FIG. 7 is a view illustrating an example of arraying keys of each key group region depending on the characteristics of the contact areas;

FIGS. 8 and 9 are views illustrating examples of implementing a method for providing a graphic keypad in a tablet PC according to exemplary embodiments of the present invention;

FIG. 10 is a flowchart illustrating another embodiment of a method for providing a graphic keyboard in accordance with the invention, which does not necessarily divide key group regions.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

The word “shape” as used herein to describe the appearance of a graphic (virtual) key or a contact area of a touch on a touch-screen, is intended to encompass not only a geographic shape such as a circle or rectangle, but also a size and orientation of the key or contact area. For instance, a first displayed rectangular key having certain dimensions but displayed in a straight orientation, i.e., with sides parallel to the sides of a rectangular portable terminal, is said to have a different shape than a second rectangular key with the same dimensions but displayed tilted with respect to the sides of the portable terminal. As a further example, a first rectangular key having certain dimensions is said to have a different shape than a second rectangular key having different dimensions, regardless of orientation.

Herein, the word “key,” when used in the context of a touch screen graphic keyboard, refers to a key icon. A key herein can also be called a graphic key or a virtual key.

Exemplary embodiments of the present invention provide a method and apparatus for providing a graphic keyboard that can reduce a typographic error depending on a personal characteristic in a touch-screen. An exemplary embodiment of the present invention controls an array of graphically displayed keys, for example, a size or width of keys, an interval between keys, a slope of keys, etc. Such control can be a function of contact area characteristics of respective touches between a user's finger and a touch-screen, for example, sizes (surface areas) of the contact areas, shapes and/or orientations of the contact areas, etc.

An exemplary embodiment of the present invention widens a spacing between keys when surface areas of the touches are large. Furthermore, in embodiments, a representative direction in which contact areas are oriented (e.g., major axis orientation of an elliptical contact area) is determined from the shapes of the contact areas, and the keys are displayed inclined in the determined direction. A key element array (key array) depending on characteristics of the contact areas may be controlled for each predetermined region. For example, a key group of a first touch region and a key group of a second touch region may be controlled as different key element arrays. As will become apparent in the below description, embodiments consider a user's experience that an unintended key may be erroneously touched when a contact area of a touch is large. Furthermore, embodiments consider a user's experience that an unintended key may be erroneously touched as a major axis direction length of a contact area shape (e.g., an ellipse) is large or a slope of the contact area's major axis with respect to the device edges is large.

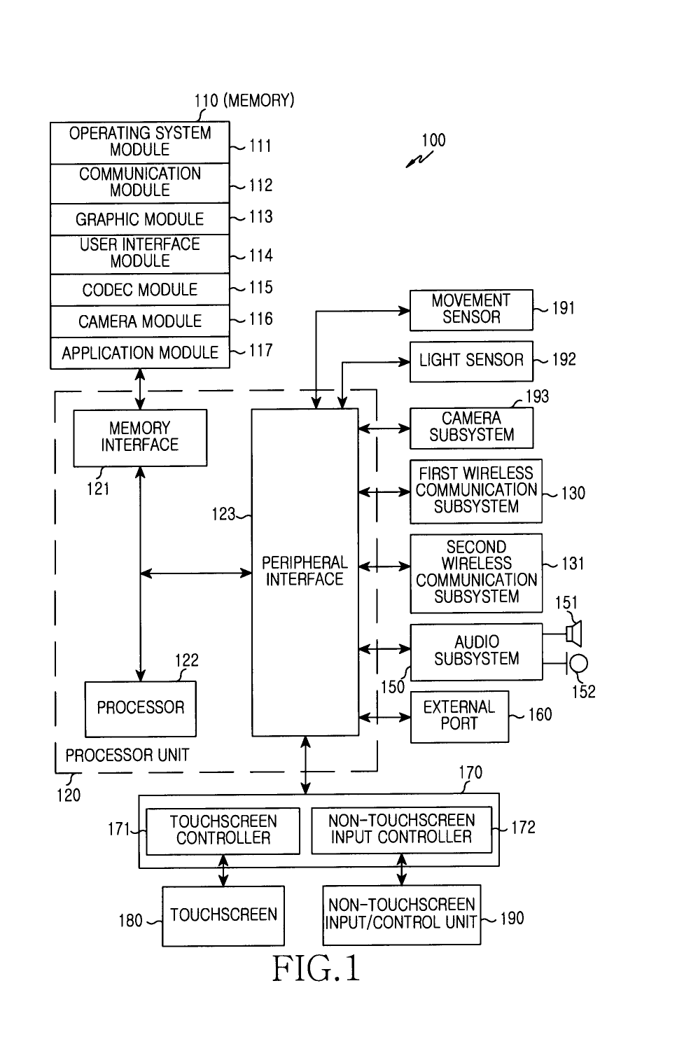

FIG. 1 is a block diagram illustrating an example electronic device according to an exemplary embodiment of the present invention. The electronic device 100 may be a hand held, portable electronic device with a touch-screen display such as a portable terminal, a mobile phone, a mobile pad, a media player, a tablet computer, a hand-held computer, or a PDA. Electronic device 100 may be an arbitrary electronic device including a device that combines two or more functions among these devices.

The electronic device 100 can include a memory 110, a processor unit 120, a first wireless communication subsystem 130, a second wireless communication subsystem 131, an external port 160, an audio subsystem 150, a speaker 151, a microphone 152, an Input/Output (I/O) subsystem 170, a touch-screen 180, and a non-touchscreen input/control unit 190. A plurality of memories 110 and external ports 160 may be configured.

The processor unit 120 includes a memory interface 121, one or more processors 122, and a peripheral interface 123. The entire processor unit 120 may be referred to herein as a processor. The memory interface 121, one or more processors 122, and/or the peripheral interface 123 may be separate elements or may be configured in one or more integrated circuits.

The processor 122 executes various software programs to perform various functions for the electronic device 100, and performs processes and controls for voice communication, video communication, and data communication. Also, in addition to these general functions, the processor 122 executes a software module (an instruction set) stored in the memory 110 to perform various functions corresponding to the module. Processor 122 can further execute a specific software module (an instruction set) stored in the memory 110 to perform various specific functions corresponding to the specific module. That is, the processor 122 performs a method of an embodiment of the present invention in cooperation with software modules stored in the memory 110.

The processor 122 may include one or more data processors, image processors, or a CODEC. The electronic device 100 may include the data processors, the image processors, or the CODEC separately. The peripheral interface 123 connects the I/O subsystem 170 of the electronic device 100 and various peripheral devices to the processor 122. Furthermore, the peripheral interface 123 connects the I/O subsystem 170 of the electronic device 100 and various peripheral devices to the memory 110 via the memory interface 121.

Various elements of the electronic device 100 may be coupled via one or more communication buses (reference numeral not shown) or stream lines (reference numeral not shown).

The external port 160 can be used for directly connecting the electronic device 100 to other electronic devices or indirectly connecting the electronic device 100 to other electronic devices via a network (for example, the Internet, an Intranet, a wireless LAN, etc.) For example, the external port 160 may be a Universal Serial Bus (USB) or a FIREWIRE port, etc. but is not limited thereto.

A movement sensor 191 and a light sensor 192 may be coupled to the peripheral interface 123 to enable various functions. For example, the movement sensor 191 and the light sensor 192 may be coupled to the peripheral interface 123 to detect movement of the electronic device 100 or detect external light. Other sensors such as a position sensor, a temperature sensor, a living body sensor, etc. may be coupled to the peripheral interface 123 to perform relevant functions.

A camera subsystem 193 may perform a camera function such as still image photography, video clip recording, etc. The light sensor 192 may be a Charged Coupled Device (CCD) or a Complementary Metal Oxide Semiconductor (CMOS) device for the camera subsystem 193.

First and second wireless communication subsystems 130 and 131 can be included to enable enhanced communication. The first and second wireless communication subsystems 130 and 131 may include a Radio Frequency (RF) receiver and an RF transceiver and/or a light (for example, infrared) receiver and a light transceiver. The first and second wireless communication subsystems 130 and 131 may be classified depending on a communication network. For example, the first and second wireless communication subsystems 130 and 131 may be designed to operate via one of a Global System for Mobile Communication (GSM) network, an Enhanced Data GSM Environment (EDGE) network, a Code Division Multiple Access (CDMA) network, a Wide-CDMA (W-CDMA) network, a Long Term Evolution (LTE) network, an Orthogonal Frequency Division Multiple Access (OFDMA) network, a Wireless Fidelity (Wi-Fi) network, a WiMax network, and/or a Bluetooth network.

The audio subsystem 150 may be coupled to a speaker 151 and a microphone 152 to handle voice recognition, voice duplication, digital recording, and input/output of an audio such a communication function. That is, the audio subsystem 150 communicates with a user via the speaker 151 and the microphone 152. The audio subsystem 150 receives a data signal via the peripheral interface 123 of the processor unit 120, converts the received data signal to an electric signal, and provides the converted electric signal to the speaker 151. The speaker 151 converts the electric signal to a sound wave audible by a human being and outputs the same. The microphone 152 converts a sound wave transferred from a human being or other sound sources to an electric signal. The audio subsystem 150 receives the electric signal from the microphone 152, converts the received electric signal to an audio data signal, and transmits the converted audio data signal to the peripheral interface 123. The audio subsystem 150 may include an attachable and detachable ear phone, a head phone, or a headset.

The I/O subsystem 170 includes a touch-screen controller 171 and a non-touchscreen input controller 172 (if other, non-touchscreen input means are provided). The touch-screen controller 171 is coupled to a touch-screen 180 and determines a touch event such as a touch contact, a touch movement, etc. via the touch-screen 180. The touch-screen 180 and the touch-screen controller 171 may use an arbitrary multi-touch detection technology including other proximity sensor arrangements or other elements as well as capacitive, resistive, infrared, and surface acoustic wave technologies. The non-touchscreen input controller 172 may be coupled to a non-touchscreen input/control unit 190. The non-touchscreen input/control unit 190 may include an up/down key element for volume control. Non-touchscreen input/control unit 190 may include at least one of a push key element, a rocker key element, a rocker switch, a thumb-wheel, a dial, a stick, and/or a pointer device such as a stylus, etc. that provides a relevant function.

The touch-screen 180 provides an input/output interface between the electronic device 100 and a user. That is, the touch-screen 180 transfers the user's touch input to the electronic device 100, and displays visual information (for example, text, graphics, video, etc.) provided from the electronic device 100 to the user.

Generally, the touch-screen 180 includes a touch panel, a touch sensor, etc. added to a display. Various displays may be used for the display. For example, the display may be one of a Liquid Crystal Display (LCD), a Light Emitting Diode (LED), a Light Emitting Polymer Display (LPD), an Organic Light Emitting Diode (OLED), an Active Matrix Organic Light Emitting Diode (AMOLED) or a Flexible LED (FLED).

The memory 110 may be coupled to the memory interface 121. The memory 110 may include a high speed random access memory such as one or more magnetic disc storage devices and/or a non-volatile memory, one or more optical storage devices and/or a flash memory (for example, NAND, NOR).

The memory 110 stores software. Software includes an operating system module 111, a communication module 112, a graphic module 113, a user interface module 114, a CODEC module 115, a camera module 116, one or more application modules 117, etc. A software module is typically called a set of instructions, an instruction set or a program.

The operation system software 111 denotes a built-in operating system such as WINDOWS, LINUX, Darwin, RTXC, UNIX, OS X, or VxWorks, and includes various software elements for controlling a general system operation. This control of the general system operation includes memory management and control, storage hardware (device) control and management, power control and management, etc. Furthermore, this operating system software performs a function for smoothing communication between various hardware (devices) and software elements (modules).

The communication module 112 may enable communication with counterpart electronic devices such as a computer, a server and/or a portable terminal, etc. via the wireless communication subsystems 130, 131 or the external port 160.

The graphic module 113 includes various software elements for providing and displaying graphics on the touch-screen 180. The term “graphics” denotes text, a web page, an icon, a digital image, a video, animation, etc.

The user interface module 114 includes various software elements related to a user interface. The user interface module 114 includes content as to how the state of the user interface is changed and under what condition a change of a user interface state is performed, etc.

The CODEC module 115 includes a software element related to encoding and decoding of a video file.

The camera module 116 includes a camera-related software element for enabling camera-related processes and functions.

The application module 117 includes a browser, an electronic mail, an instant message, word processing, keyboard emulation, an address book, a touch list, a widget, Digital Right Management (DRM), voice recognition, voice duplication, position determining function, location based service, etc. The memory 110 may further include one or more additional modules (set of instructions) besides the above-described modules.

Also, various functions of the electronic device 100 according to the present invention may be executed by one or more stream processors and/or hardware including an Application Specific Integrated Circuit (ASIC) and/or software and/or combination of these.

The processor 122 may execute at least one module stored in the memory 110, and the module may provide a graphic keyboard in a touch-screen terminal according to the present invention.

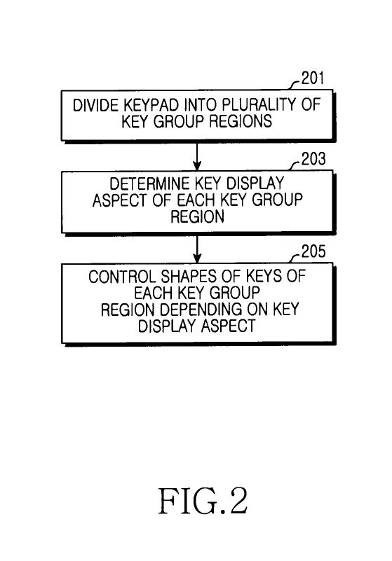

Furthermore, the processor 122 configures a graphic keyboard providing means that uses at least one element illustrated in FIG. 1. For example, the processor 122 configures a means for dividing a keyboard into a plurality of key group regions, a means for determining a key display aspect of each key group region, and a means for controlling shapes of the keys of each key group region based on the key display aspect. Furthermore, the processor 122 may include a means for determining characteristic(s) of contact areas of touches on keys and a means for controlling the shape of keys based on the characteristic(s). Detailed description thereof is provided below with reference to FIG. 2.

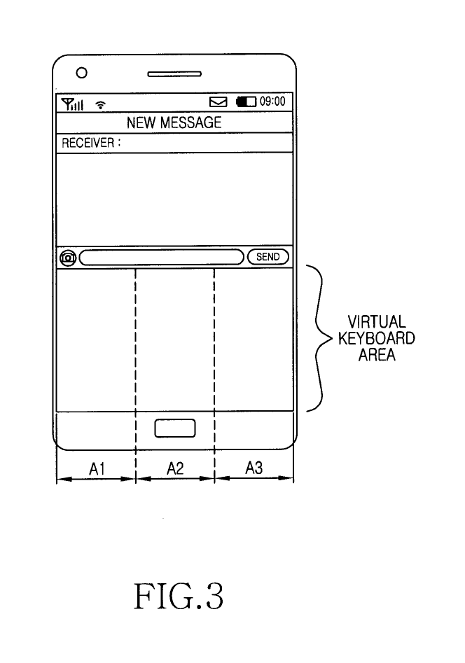

FIG. 2 is a flowchart illustrating a method for providing a graphic keyboard according to an exemplary embodiment of the present invention. The method begins at step 201, where the processor 122 divides a keyboard into a plurality of key group regions or touch regions. For example, FIG. 3 illustrates an exemplary embodiment of dividing the keyboard into three key group regions A1, A2, and A3 in a virtual keyboard area. Each key group region includes a plurality of keys. Processor 122 can either predetermine the number and boundaries of the key group or touch regions, or, the regions can be defined after the user has inputted a predetermined number of key strokes on an initial virtual keyboard that is first displayed. The initial virtual keyboard can be a conventional uniform keyboard (e.g., QWERTY type) in which all keys are uniform in size and uniformly spaced from one another. When the user inputs one of the predetermined number of key strokes via touch input, the contact area for that touch can be determined, stored and analyzed.

The contact area refers to the particular points (coordinates), on the touch screen for which touch has been detected. Each point may correspond to a pixel, for example. Because the touch screen is of much higher resolution than the user's finger, each touch results in many high resolution touch points being detected, whereby processor 122 can compute a closed contour of a contact area for that touch. Typically, the closed contour is circular or elliptical. If elliptical, processor 122 can determine the direction of a major axis of the ellipse via suitable algorithm, and thereby estimate the orientation of the contact area, and hence, the orientation of the user's finger when the touch was made. Since the orientation is an indication of how the user is holding the device 100, processor 122 can modify key shapes in different regions to better accommodate the user's fingers in the current gripping position. Further, the processor can determine the size of the contact area, i.e., the amount of surface area touched. In defining key group regions, processor 122 thus may consider characteristics of the contact areas of respective touches, e.g., at least one of the sizes of the contact areas and the shapes (closed contours) of the contact areas.

Next, the processor 122 determines a “key display aspect” of each key group region in step 203. The key display aspect may limit a control range of the size or width of keys, a control range of an interval between the keys, or a control range of the slope of the key elements. The key display aspect sets a layout style of key elements. For example, a key display aspect may be a layout style that displays a key located relatively on the left, in a larger size than keys in the center or right side of the keyboard. Another key display aspect may be a style that tilts a group of keys left or right compared to the left and right sides of the device 100. Still another key display aspect may be a style that both enlarges and tilts the keys. The memory 110 can store a plurality of key display aspects (type, style), and the processor 122 can select and determines a key display aspect to be applied to each key group region, or to each touch region. For example, the processor 122 may determine the key display aspect in consideration of one or more characteristics of contact areas of recent touches of each key group or touch region. The characteristics of a contact area can include the size and shape of the contact area.

For example, the processor 122 can calculate an average of sums of sizes (surface areas) of contact areas of respective touches on each key group region based on the number of times of touches, and select and determine the key display aspect corresponding to the calculated average. Furthermore, the processor 122 may determine a representative direction in which the contact areas are disposed lengthwise (for elliptical or rectangular contact areas) from the shapes of the contact areas, and select and determine the key display aspect corresponding to the determined direction. (Note that when a circular contact area is detected, lengths in all directions are equal; thus the representative direction is not determined for this case.)

Next, the processor 122 controls the shapes and/or layouts of the keys of the key group region depending on the key display aspect in step 205. The processor 122 controls at least one of the size or width of the keys and the spacing between the keys to conform to the key display aspect determined from the sizes of the contact areas. Furthermore, the processor 122 may display the keys slanted to conform to the key display aspect determined from the shapes of the contact areas. Examples to illustrate the key shapes determination are presented below.

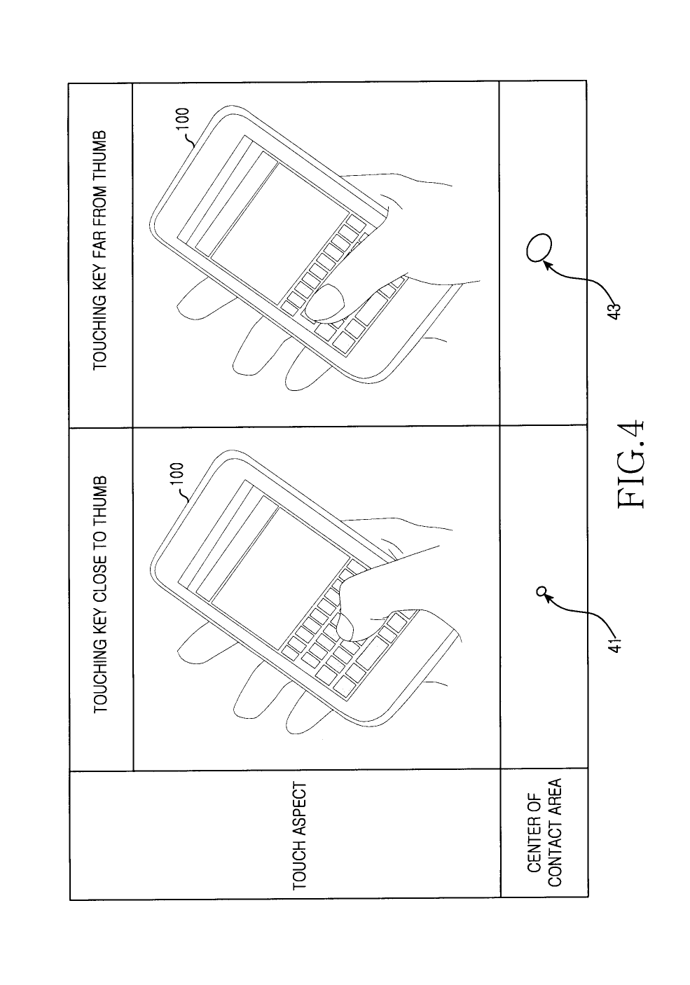

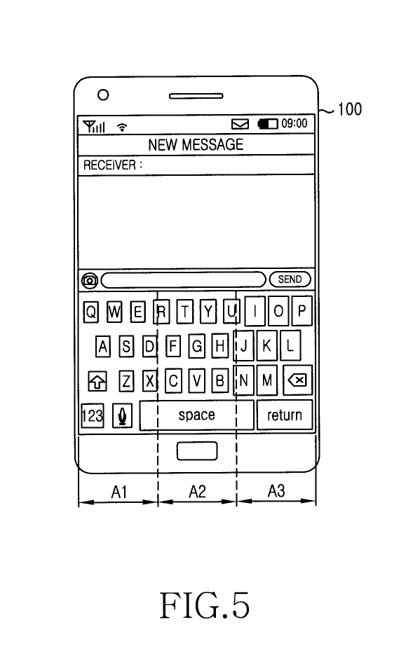

FIG. 4 is a view illustrating characteristics of contact areas of touches in different key group regions of a keyboard. In the case where a user touches keys using a thumb of a hand gripping a terminal 100, the contact area may differ for different touch regions. For example, in case of a touch region close to the thumb (left side view), a degree of bending the thumb is large, whereby a contact area 41 is small. In case of a touch region far from the thumb (right side view), a degree of bending the thumb is small, whereby a contact area 43 is large. When the contact area is large, the possibility that a user may touch an unintended key is relatively high. Accordingly, in embodiments of the invention, the keyboard layout is dynamically changed by re-arranging key sizes, spacing between keys, and/or key orientations to reflect the manner in which the keys are currently being touched. The rearrangement can be a region by region approach, as exemplified in FIG. 5 below. Alternatively, rearrangement can be done at an individual key level rather than a region level. Herein, a keyboard rearrangement is a change in shape or layout of at least one key (where a “change in shape” is intended to include the possibility of a change in orientation and/or size as well as a change in geometric shape). Note that a change in layout for a group of keys may occur even if the same shapes are maintained for the keys in that group, by changing the spacing between keys, i.e., spreading the keys apart or bringing them closer together.

FIG. 5 is a view illustrating an example of arraying keys of each key group region based on at least one characteristic of contact areas of touches. In accordance with embodiments, an array of keys of each key group region can conform to a “key display aspect” (e.g., style) determined by characteristics of contact areas of recent touches. For example, FIG. 5 may represent a keyboard layout determined on the basis of a predetermined number of recent touches. Keys of a relevant key group region are controlled to predetermined sizes, widths, and intervals depending on a designated key display aspect. In the example illustrated, the processor 122 generates a keyboard layout that conforms to a key display aspect that widens a spacing between keys in the left side region A1. Concurrently, the spacing between keys in the right side region A3 is reduced. This keyboard layout may be generated responsive to contact areas of touches detected as illustrated in FIG. 4. That is, contact areas in the left hand region A1 were detected to be relatively large, whereby increasing the spacing between keys would result in less errors. On the other hand, spacing between keys is reduced in region A3, as the processor 122 determines, based on the contact area characteristics, even a reduced spacing would not lead to excessive input errors in that region. The sizes of the respective keys may be modified as well based on the detected contact area characteristics, in any manner sufficient to reduce erroneous input.

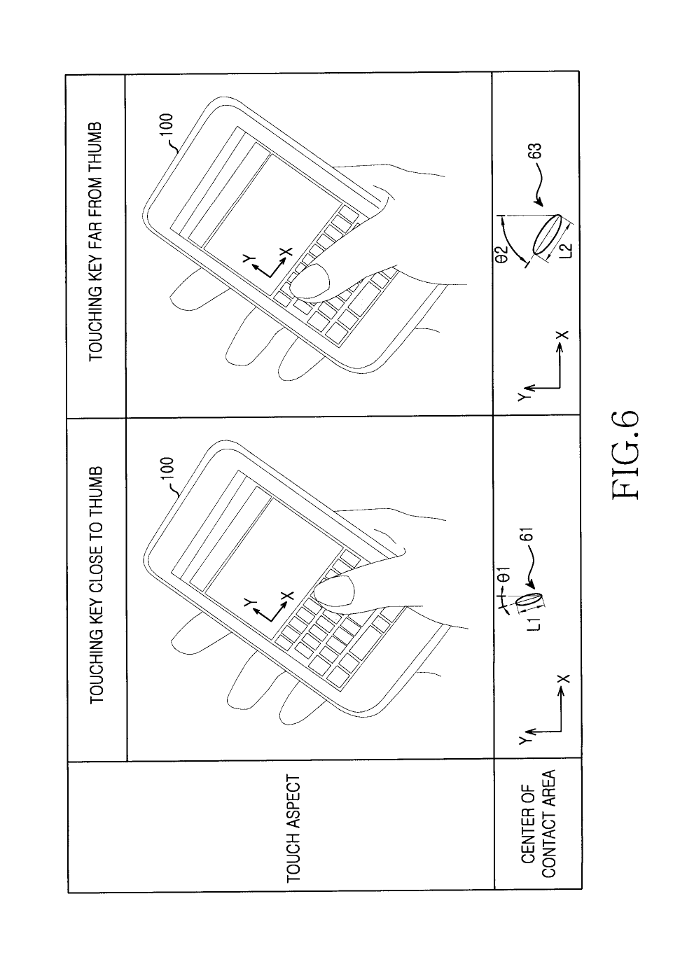

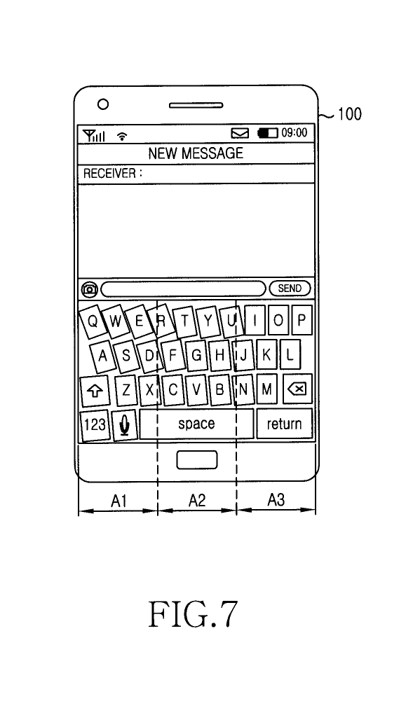

FIG. 6 is a view illustrating characteristics of contact areas of touches for different key group regions of a keyboard FIG. 7 is a view illustrating an example of arraying keys of each key group region depending on the characteristics of the contact areas,. Referring to FIG. 6, in the case where a user touches using a thumb gripping device 100, different contact area shapes are generated for each touch region. In case of a touch region far from the thumb (far side region, right side view), the length of a generated contact shape 61 is relatively longer (L2>L1) than that of a closer region to the thumb (left side view). Further, the direction in which the contact area is disposed lengthwise, i.e., the orientation of the contact area, is inclined relatively further in the far side region (θ2>θ1). Note that length of a contact area is the length in a major axis direction of a contact area that is elliptical, as in FIG. 6. (Length can also be considered a length of a diameter in a circular contact area case. However, orientation angles are not relevant for circular contact areas. A circular contact area case was illustrated in FIG. 4.) Orientation of the contact area (or of a key) is relative to the orientation of the left and right sides of the device 100 or of the left and right sides of the touch screen (see X and Y reference axes in FIG. 6).

The fact that the length of the contact area increases or the orientation of the contact area is inclined means that a neighbor key may be easily touched erroneously. As mentioned above, an array of keys of each key group region can be designed to conform to a key display aspect determined by characteristics of the contact areas. For example, in FIG. 7, the processor 122 conforms the layout to a key display aspect that inclines far side keys of a far side key group region A1 more than the near side keys (relative to a user's thumb) of region A3. Keys of the relevant key group region are displayed slanted at predetermined slopes that conform to a designated key display aspect. For example, a key disposed to the left is inclined further. Consequently, by inclining the key, the probability that a user touches an unintended key is reduced.

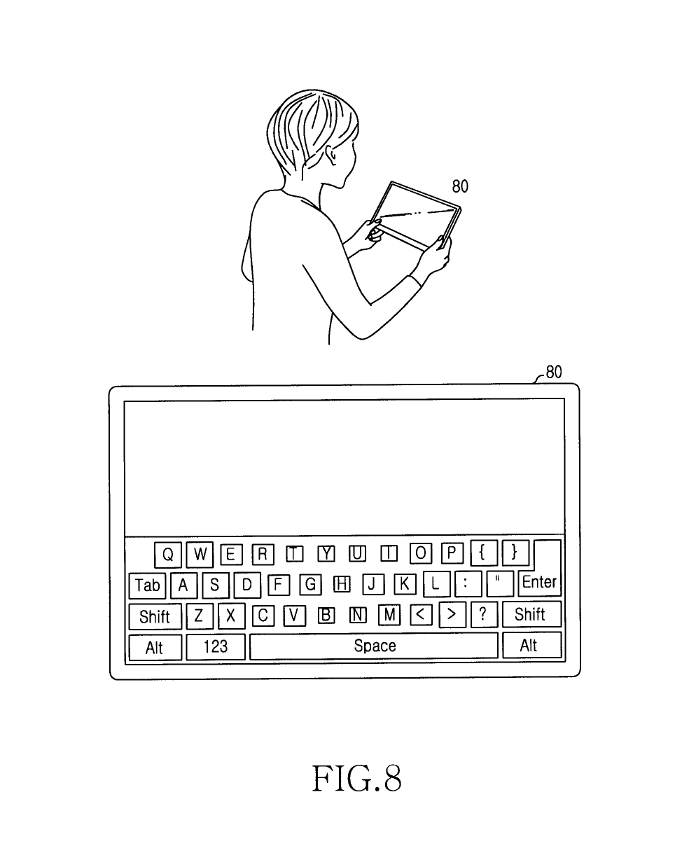

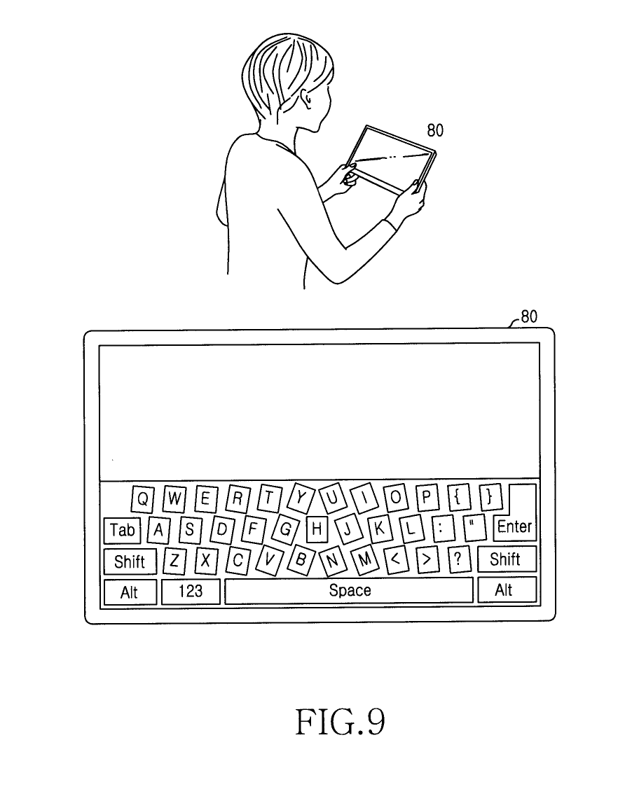

FIGS. 8 and 9 are views illustrating examples of implementing a method for providing a graphic keyboard in a tablet PC according to exemplary embodiments of the present invention. Generally, a user takes a tablet PC 80 (example of device 100) with both hands to touch a keyboard with thumbs of both hands.

Referring to FIG. 8, an embodiment of the present invention controls a size of keys or an interval between keys as a function of the sizes (surface areas) of contact areas between thumbs of both hands and the touch-screen. For example, center keys of the keyboard are realized in a size smaller than left/right side keys. Referring to FIG. 9, an embodiment of the present invention controls a key slope in consideration of the shapes of contact areas between thumbs of both hands and the touch-screen. For example, the slopes of center keys of the keyboard are greater than those of the left/right keys.

Embodiments of FIGS. 4 to 9 depict examples that consider either the sizes of contact areas or the shapes of the contact areas. The present invention is not limited thereto but may control the size or width of keys, an interval between keys, and the slope of keys for each key group region in consideration of both the sizes of the contact areas and the shapes of the contact areas.

Furthermore, an alternative embodiment of the present invention may not divide the key group regions, may determine a characteristic(s) of contact areas depending on respective key touches, and may control the shape or layout of at least one key based on the determined characteristic(s) of the contact areas.

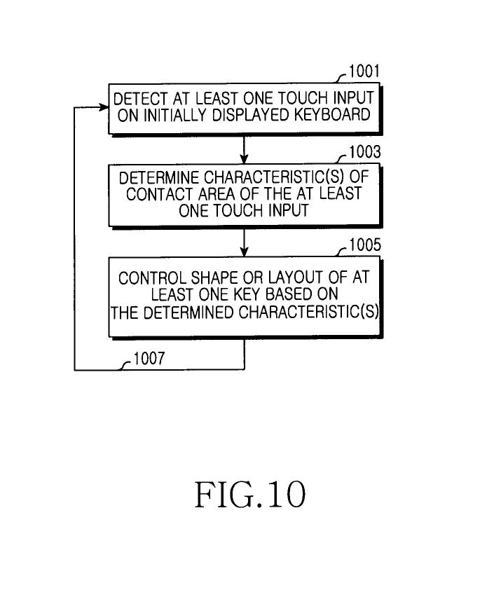

FIG. 10 is a flowchart illustrating another embodiment of a method of providing a graphic keyboard in accordance with the invention, which does not necessarily divide key group regions. At step 1001, at least one touch input is detected on an initially displayed keyboard on device 100. Next, at least one characteristic of a contact area of at least one touch on in the keyboard area is determined (1003). The at least one characteristic can be size or orientation of the contact area, or a combination thereof Based on the determined characteristic(s), shape and/or layout of at least one key of the keyboard is controlled (1005). For instance, only layout between keys might be changed by shifting the keys relative to another without changing their shapes or sizes, i.e., by just changing the spacing between certain keys. Or, slant of keys may be changed in accordance with detected slant of the contact areas, as described above. The keyboard layout may be caused to change dynamically (indicated by path 1007) as the user changes his grip on the device 100, switches hands, etc., which results in the contact areas changing. As the contact areas change, the processor 122 may detect such changes and modify the keyboard layout accordingly.

Consequently, methods and apparatus for providing a keyboard in a touch-screen terminal according to the present invention provide an interactive graphic keyboard that can reduce a typographic error depending on a personal touch characteristic.

Methods according to embodiments described in claims and/or specification of the present invention may be implemented in the form of software, hardware, or a combination of these.

In case of implementation in the form of software, a computer readable storage medium storing one or more programs (software modules) may be provided. The one or more programs stored in the computer readable storage medium are configured for execution by one or more processors inside the electronic device. The one or more programs include instructions for allowing the electronic device to execute methods according to the embodiments described in claims and/or specification of the present invention.

These programs (software modules, software) may be stored in a random access memory, a non-volatile memory including a flash memory, Read Only Memory (ROM), an Electrically Erasable Programmable Read Only Memory (EEPROM), a magnetic disc storage device, a Compact Disc (CD)-ROM, Digital Versatile Discs (DVDs) or other types of optical storage devices, and a magnetic cassette. Alternatively, these programs may be stored in a memory configured in a combination of some or all of these. Also, a plurality of respective memories may be provided.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for providing a graphic keyboard in a touch-screen terminal, the method comprising:
dividing a graphic keyboard display area into a plurality of key group regions;
determining a key display aspect of each key group region; and
controlling a shape or layout of at least one key in each key group region based on the key display aspect of that group.

2. The method of claim 1, wherein the dividing of the keyboard into the plurality of key element set regions comprises:
determining a key group region to which keys belong as a function of contact area characteristics of respective touches on the keys, the contact area characteristic of a respective touch comprising at least one of size, shape and orientation of contact area for that touch.

3. The method of claim 1, wherein the key display aspect of each key group region comprises at least one of: a style regarding a size or a width of the keys, a style regarding spacing between keys, or a style regarding a slope of the keys.

4. The method of claim 1, wherein determining of the key display aspect of each key group region comprises:
determining the key display aspect as a function of contact area characteristics of respective touches on the key regions, the contact area characteristics comprising at least one of size, shape and orientation of the contact area.

5. The method of claim 4, wherein determining of the key display aspect of each key group region comprises: calculating an average of sums of surface areas of the contact areas based on the number of times of touches, and selecting and determining a key display aspect associated with the average.

6. The method of claim 5, wherein controlling a shape or layout of at least one key comprises:
controlling at least one of a size or a width of keys and a space between keys depending on the key display aspect.

7. The method of claim 4, wherein determining of the key display aspect of each key group region comprises:
determining a representative direction in which a plurality of contact areas are oriented from shapes of the contact areas and selecting and determining the key display aspect associated with the determined direction.

8. The method of claim 7, wherein controlling a shape or layout of at least one key comprises:
inclining keys on the basis of the key display aspect.

9. A method for providing a graphic keyboard in a touch-screen terminal, the method comprising:
determining a characteristic of a contact area of at least one touch on at least one graphic key of a displayed keyboard; and
controlling a shape or layout of the at least one key based on the determined characteristic.

10. The method of claim 9, wherein the characteristic of the at least one contact area is at least one of a size, a shape and an orientation of the at least one contact area.

11. The method of claim 10, wherein controlling a shape or layout of the at least one key comprises:
calculating an average of sums of surface areas of contact areas based on a number of times of touches, and controlling shapes or layouts of the keys using a size or a width associated with the calculated average.

12. The method of claim 10, wherein controlling a shape or layout of the at least one key comprises:
determining a representative direction in which a plurality of contact areas of respective touches are oriented from characteristics of the contact areas, and inclining the at least one key in the determined direction.

13. The method of claim 9, wherein controlling a shape or layout of the at least one key comprises:
controlling a size or a width of the at least one key or controlling a slope of the at least one key.

14. An electronic device for providing a graphic keyboard, the device comprising:
a touch-screen;
a memory; and
at least one processor,
wherein the at least one processor executes at least one module stored in the memory, and
the module divides a keyboard display area into a plurality of key group regions, determines a key display aspect of each key group region, and controls a shape or layout of at least one key of each key group region based on the key display aspect of that group.

15. The device of claim 14, wherein when dividing the keyboard into the plurality of key group, the module determines a key group region to which keys belong as a function of contact area characteristics of respective touches on the keys, the contact area characteristics of a respective touch comprising at least one of size, shape and orientation of contact area for that touch.

16. The device of claim 14, wherein the key display aspect of each key group region comprises at least one of: a style regarding a size or a width of the key elements, a style regarding an interval between key elements, or a style regarding a slope of the key elements.

17. The device of claim 14, wherein when determining the key display aspect of each key group region, the module determines the key display aspect as a function of contact area characteristics of respective touches on the key regions, the contact area characteristics of a respective touch comprising at least one of size, shape and orientation of contact area for that touch.

18. The device of claim 17, wherein when determining the key display aspect of each key group region, the module calculates an average of sums of surface areas of the contact areas based on the number of times of touches, and selects and determines a key display aspect associated with the average.

19. The device of claim 18, wherein when controlling a shape or layout of at least one key, the module controls at least one of a size or width of keys and a spacing between the keys depending on the key display aspect.

20. The device of claim 17, wherein when determining the key display aspect of each key group region, the module determines a representative direction in which a plurality of contact areas are oriented from shapes of the contact areas and selects and determines the key display aspect associated with the determined direction.

21. The device of claim 20, wherein when controlling a shape or layout of at least one key, the module inclines keys on the basis of key display aspect.

22. An electronic device for providing a graphic keyboard, the device comprising:
a touch-screen;
a memory; and
at least one processor,
wherein the at least one processor executes at least one module stored in the memory, and
the module determines a characteristic of a contact area of at least one touch on at least one graphic key of a displayed keyboard, and controls a shape or layout of the at least one key based on the determined characteristic.

23. The device of claim 22, wherein when the characteristic of the at least one contact area is at least one of a size, a shape and an orientation of the at least one contact area.

24. The device of claim 23, wherein when controlling a shape or layout of the at least one key, the module calculates an average of sums of surface areas of contact areas based on a number of times of touches, and controls shapes or layouts of the keys using a size or a width associated with the calculated average.

25. The device of claim 23, wherein when controlling a shape or layout of the at least one key, the module determines a representative direction in which a plurality of contact areas of respective touches are oriented from characteristics of the contact areas, and inclines the at least one key in the determined direction.

26. The device of claim 22, wherein when controlling a shapes or layout of the at least one key, the module controls a size or a width of the at least one key or controls a slope of the at least one key.
